(19) United States
(12) Patent Application Publication
(10) Pub. No.: US 2024/0306125 A1
(43) Pub. Date: Sep. 12, 2024

(54) PAGING METHOD, COMPUTER-READABLE STORAGE MEDIUM, AND USER EQUIPMENT

(71) Applicant: SPREADTRUM COMMUNICATIONS (SHANGHAI) CO., LTD., Shanghai (CN)

(72) Inventors: Huayu ZHOU, Shanghai (CN); Zhengang PAN, Shanghai (CN)

(21) Appl. No.: 18/578,755

(22) PCT Filed: Dec. 30, 2021
(86) PCT No.: PCT/CN2021/142874

§ 371 Date: Jan. 12, 2024

(30) Foreign Application Priority Data
Jul. 12, 2021 (CN) 202110785715.2

(51) Int. Cl. H04W 68/02; H04W 52/02

(52) U.S. Cl. CPC H04W 68/02; H04W 52/0235

(57) ABSTRACT

Provided are a paging method, a computer-readable storage medium, and a user equipment. The method comprises: detecting a wake-up signal; and monitoring a paging occasion (PO) or a paging early indication (PEI). In the technical solution provided in the embodiments of the present disclosure, the conversion power used by a user equipment to wake up from a deep sleep and the power used for signal detection are reduced.

### TECHNICAL FIELD

The present disclosure relates to the technical field of communication technology and, in particular, to a paging method, a computer-readable storage medium, and a user equipment.

### BACKGROUND

At present, the integrated receiver is used for handling synchronization signal block bursts and monitoring the physical downlink control channel (PDCCH). Therefore, the conversion power consumption of user equipment (UE) for waking up from a deep sleep state is relatively high, and the power consumption for detecting paging early indication (PEI) is also relatively high.

However, in the related art, there is no solution for reducing the conversion power consumption of user equipment for waking up from the deep sleep state and the power consumption for detecting signals.

### SUMMARY

In view of the above, embodiments of the present disclosure provide a paging method, a computer-readable storage medium, and a user equipment to reduce the conversion power consumption of user equipment for waking up from the deep sleep state and the power consumption for detecting signals.

In the first aspect, embodiments of the present disclosure provide a paging method, and the method includes: detecting a wake-up signal successfully, and monitoring a paging occasion (PO) or a paging early indication (PEI).

In an embodiment, the step of detecting a wake-up signal successfully, and monitoring a PO or a PEI includes: monitoring the PO or the PEI according to a higher layer parameter.

In an embodiment, the step of monitoring a PO or a PEI includes: monitoring the PO or the PEI according to a configuration of the PO and/or a configuration of the PEI.

In an embodiment, the user equipment monitors the PO or the PEI in response to a determination that a first user equipment group includes a second user equipment group. The first user equipment group is a user equipment group corresponding to the wake-up signal, and the second user equipment group is a user equipment group corresponding to the PEI.

In an embodiment, the first user equipment group includes the second user equipment group. The first user equipment group is the user equipment group corresponding to the wake-up signal, and the second user equipment group is the user equipment group corresponding to the PEI.

In an embodiment, the UE monitors the PO or the PEI in response to a determination that the first user equipment group includes a third user equipment group. The first user equipment group is the user equipment group corresponding to the wake-up signal, and the third user equipment group is a user equipment group corresponding to the PO.

In an embodiment, the first user equipment group includes the third user equipment group. The first user equipment group is the user equipment group corresponding to the wake-up signal, and the third user equipment group is the user equipment group corresponding to the PO.

In an embodiment, the user equipment monitors the PEI in response to a determination that the configuration of the PEI includes information on a short message, a tracking reference signal (TRS), or a channel state information reference signal (CSI-RS).

In the second aspect, embodiments of the present disclosure provide a paging method, and the method includes: detecting a wake-up signal successfully, and monitoring a paging occasion (PO) or a paging early indication (PEI) associated with the wake-up signal.

In an embodiment, the wake-up signal is detected before monitoring the PO or the PEI associated with the wake-up signal.

In an embodiment, the successful detection of the wake-up signal is prior to N synchronization signal block bursts before the PO associated with the wake-up signal.

In an embodiment, the successful detection of the wake-up signal is X milliseconds or X time slots prior to the PO associated with the wake-up signal.

In an embodiment, the successful detection of the wake-up signal is prior to M synchronization signal block bursts before the PEI associated with the wake-up signal.

In an embodiment, the successful detection of the wake-up signal is Y milliseconds or Y time slots prior to the PEI associated with the wake-up signal.

In an embodiment, the method further includes: detecting the wake-up signal successfully, and monitoring a PO or a PEI after a first time gap.

In an embodiment, the step of detecting the wake-up signal successfully, and monitoring a PO or a PEI after a first time gap includes: detecting the wake-up signal successfully, and monitoring the PO or the PEI after a first time point.

In an embodiment, the step of detecting the wake-up signal successfully, and monitoring a PO or a PEI after a first time gap includes: detecting the wake-up signal successfully, and monitoring the PO after N synchronization signal block bursts subsequent to the first time point.

In an embodiment, the step of detecting the wake-up signal successfully, and monitoring a PO or a PEI after a first time gap includes: detecting the wake-up signal successfully, and monitoring the PO X milliseconds or X time slots after the first time point.

In an embodiment, the X milliseconds or X time slots include N synchronization signal block bursts.

In an embodiment, the step of detecting the wake-up signal successfully, and monitoring a PO or a PEI after a first time gap includes: detecting the wake-up signal successfully, and monitoring the PEI after M synchronization signal block bursts subsequent to the first time point.

In an embodiment, the step of detecting the wake-up signal successfully, and monitoring a PO or a PEI after a first time gap includes: detecting the wake-up signal successfully, and monitoring the PEI Y milliseconds or Y time slots after the first time point.

In an embodiment, the Y milliseconds or Y time slots include M synchronization signal block bursts.

In an embodiment, the first time point is an end time point of the wake-up signal.

In the third aspect, embodiments of the present disclosure provide a paging method, and the method includes: stopping detecting a wake-up signal within a second time gap.

In an embodiment, the step of stopping detecting a wake-up signal within a second time gap includes: stopping detecting all wake-up signals, in one paging cycle of P paging cycles, associated with a paging occasion (PO).

In an embodiment, the step of stopping detecting all wake-up signals, in one paging cycle of P paging cycles, associated with a PO includes: stopping detecting all wake-up signals, in a first paging cycle or a last paging cycle of the P paging cycles, associated with the PO.

In an embodiment, the step of stopping detecting a wake-up signal within a second time gap includes: stopping detecting the wake-up signal within a time window.

In an embodiment, a duration of the time window includes: a duration of a synchronization signal block burst; or a duration of a synchronization signal block measurement timing configuration (SMTC).

In an embodiment, the duration of the time window includes: N synchronization signal block bursts and the PO; or N synchronization signal bursts, the PO and the SMTC.

In an embodiment, the duration of the time window is X milliseconds or X time slots, and the X milliseconds or X time slots includes: N synchronization signal block bursts and the PO; or N synchronization signal bursts, the PO and the SMTC.

In an embodiment, the duration of the time window includes: N synchronization signal bursts, a paging early indication (PEI) and the PO; or N synchronization signal bursts, the PEI, the PO and the SMTC.

In an embodiment, the duration of the time window is X milliseconds or X time slots, and the X milliseconds or X time slots include: N synchronization signal bursts, the PEI and the PO; or N synchronization signal bursts, the PEI, the PO, and the SMTC.

In the fourth aspect, embodiments of the present disclosure provide a computer-readable storage medium, and the computer-readable storage medium includes a program stored therein. The program, when being executed, causes an equipment equipped with the computer-readable storage medium to implement the paging method according to the first aspect or any one of embodiments in the first aspect, or the paging method according to the second aspect or any one of embodiments in the second aspect, or the paging method according to the third aspect or any one of embodiments in the third aspect.

In the fifth aspect, embodiments of the present disclosure provide a user equipment, and the user equipment includes: one or more processors, a memory, and one or more computer programs. The one or more computer programs are stored in the memory, the one or more computer programs include instructions, and the instructions, when being executed by the user equipment, cause the user equipment to implement the paging method according to the first aspect or any one of embodiments in the first aspect, or the paging method according to the second aspect or any one of embodiments in the second aspect, or the paging method according to the third aspect or any one of embodiments in the third aspect.

The technical solution of the paging method according to the embodiment of the present disclosure includes: detecting a wake-up signal successfully, and monitoring a paging occasion (PO) or a paging early indication (PEI). Through the technical solution provided by the embodiment of the present disclosure, the conversion power consumption of user equipment waking up from deep sleep and the power consumption for detecting signals are reduced.

### BRIEF DESCRIPTION OF DRAWINGS

In order to better describe the technical solutions in the embodiments of the present disclosure, the drawings which are needed in the description of the embodiments will be briefly introduced as follows. It is appreciated that, the drawings in the following description are only some of the embodiments of the present disclosure, and for those of ordinarily skilled in the art, other drawings can also be obtained in accordance with these drawings without any creative effort.

FIG. 1 is a flowchart of a paging method according to an embodiment of the present disclosure;

FIG. 2 is a flowchart of another paging method according to an embodiment of the present disclosure;

FIG. 3 is a flowchart of another paging method according to an embodiment of the present disclosure;

FIG. 4 is a flowchart of another paging method according to an embodiment of the present disclosure; and

FIG. 5 is a schematic diagram of a user equipment according to an embodiment of the present disclosure.

### DESCRIPTION OF EMBODIMENTS

In order to better understand the technical solutions of the present disclosure, embodiments of the present disclosure will be described in detail in conjunction with the drawings hereinafter.

It should be clarified that the described embodiments are only a portion of the embodiments of the present disclosure, and not all of them. Based on the embodiments of the present disclosure, all other embodiments obtained by those skilled in the art without creative effort fall within the protection scope of the present disclosure.

The terms used in the embodiments of the present disclosure are for the purpose of describing specific embodiments, and are not intended to limit the present disclosure. The terms “a/an”, “said” and “the” in singular form in the embodiment of the present disclosure and the attached claims are also intended to include the majority form, unless other meanings are clearly indicated by the contexts.

It should be understood that the term “and/or” herein is only used to describe an association of the related objects, and the term indicates that there can be three associations. For example, A and/or B can indicate the following three situations: only A, both A and B, and only B. In addition, the character “/” herein generally indicates that the association between the associated objects before and after the character is an “or” association.

In Rel-15 NR, synchronization signals and broadcast channels are sent in the form of synchronization signal block, and beam sweeping is introduced. A primary synchronization signal (PSS), a secondary synchronization signal (SSS) and a physical broadcast channel (PBCH) are in a synchronization signal block (SS/PBCH block). Each synchronization signal block may serve as a resource for a beam (analog domain) during a beam sweeping process. Multiple synchronization signal blocks constitute a synchronization signal burst (SS burst). The synchronization signal burst may serve as a relatively concentrated resource including multiple beams. Multiple synchronization signal bursts constitute a synchronization signal burst set (SS-burst-set). The synchronization signal block is repeatedly sent on different beams, which is a beam sweeping process. A user equipment, trained by the beam sweeping, may sense on which beam the received signal is strongest. The time domain positions of L synchronization signal blocks are stationary within a 5 ms window. The indexes of L synchronization signal blocks are arranged successively from 0 to L−1 in the time domain positions. Therefore, a transmission time point of the synchronization signal block within this 5 ms window is stationary, and the index is also stationary.

Remaining minimum system information (RMSI) in Rel-15 NR corresponds to SIB1 in LTE, which includes the main system information except for a master information block (MIB). RMSI can also be referred to as SIB1. RMSI is carried in a physical downlink share channel (PDSCH), and the PDSCH is scheduled through PDCCH. The PDSCH that carries RMSI is generally referred to as RMSI PDSCH, and the PDCCH that schedules RMSI PDSCH is generally referred to as RMSI PDCCH. A search space set generally includes properties such as a search space type and a monitoring occasion of PDCCH. The Search space set is generally bundled to a control resource set (CORESET), and the CORESET includes properties such as a duration and a frequency domain resource of PDCCH. The search space set where RMSI PDCCH is located is generally referred to as Type0 PDCCH search space set. Type0-PDCCH search space set configured by MIB or radio resource control (RRC) during switching and other situations is generally referred to as search space 0 (or search space set 0), and the bundled CORESET is referred to as CORESET 0. Except for the search space set of RMSI PDCCH, other public search spaces or public search space sets, such as the search space set (Type0A-PDCCH search space set) of OSI PDCCH, the search space set (Type1-PDCCH search space set) of RAR PDCCH, and the search space set (Type2-PDCCH search space set) of paging PDCCH, can be the same as search space set 0 by default. The above public search spaces or public search space sets can generally be reconfigured. There is an association between the monitoring occasion of RMSI PDCCH and the synchronization signal block. This association is obtained by UE based on a monitoring occasion table of RMSI PDCCH. During an initial access process, a synchronization signal block is successfully detected by UE, and the time domain position (starting notation index or the first notation index) of the RMSI PDCCH associated with the synchronization signal block is determined by UE based on a row index of the table indicated by PBCH, in such a manner that RMSI PDCCH can be detected, and RMSI PDSCH is received and decoded based on RMSI PDCCH scheduling.

UE needs to obtain timing information through the synchronization signal block. Timing information, also be referred to as frame timing information or half-frame timing information, is generally used to indicate the timing of the frame or half frame corresponding to the detected synchronization signal. After obtaining the frame timing information, UE obtains the complete timing information of the cell corresponding to the synchronization signal block through a system frame number (SFN). After obtaining the half-frame timing information, UE obtains the complete timing information of the cell corresponding to the synchronization signal block through a half-frame indication (former half frame or latter half frame) and the SFN. UE generally obtains timing information within 10 milliseconds by obtaining the index of the synchronization signal block. In a licensed spectrum, the index of the synchronization signal block is associated with the L candidate positions of the synchronization signal block. When L=4, two least significant bits (2 LSBs) of the index of the synchronization signal block are carried in PBCH-DMRS (PBCH demodulation reference signal). When L>4, three least significant bits (3 LSBs) of the index of the synchronization signal block are carried in PBCH-DMRS. When L=64, three most significant bits (3 MSBs) of the index of the synchronization signal block are carried in PBCH payload or MIB.

In Rel-15 NR, UE decodes RMSI PDCCH, obtains multiple bits allocated in time domain resource, and accesses a predefined table according to these bits to obtain the starting notation index (or number) and notation length (or duration) of RMSI PDSCH. In Rel-15 NR, when UE is in the initial access process, it is assumed that rate matching is not performed on the synchronization signal block for RMSI PDSCH. RMSI may indicate whether a synchronization signal block transmits information, and after UE obtains RMSI, UE may perform rate matching on the synchronization signal block indicated by RMSI.

In Rel-15 NR, a paging occasion (PO) corresponding to a given UE includes multiple Paging PDCCH monitoring occasions. Within a PO, paging PDCCH may be sent through beam sweeping like the synchronous signal block. Within a PO, the paging PDCCH monitoring occasions are in one-to-one correspondence with the synchronization signal blocks. Within a PO, the K^{th} paging PDCCH monitoring occasion corresponds to the K^{th} synchronization signal block.

In LTE Enhanced MTO (eMTC) of LTE Rel-13, eMTC UE is a narrowband UE. eMTC UE has a bandwidth of approximately 1 MHz which can cover 6 PRBs. Therefore, eMTC UE can detect PSS, SSS, and/or PBCH of LTE during the initial access process. Due to the MIB carried within PBCH, eMTC UE can obtain the MIB of LTE by decoding. Moreover, the MIB of LTE has 10 spare bits, some of which can be used to carry the information for scheduling the SIB1 (SIB1-BR, different from LTE SIB1) of eMTC. The frequency domain resource of PDSCH carrying eMTC SIB1 are also within 6 PRBs by default, and thus eMTC UE can also receive PDSCH carrying eMTC SIB1. In this way, after decoding the MIB of LTE, eMTC UE obtains eMTC SIB1 information and access the network.

In NR, UE generally supports a bandwidth of 100 MHz. UE blindly checks the PSS, SSS, and/or PBCH in the synchronization signal block during the initial access process, and obtains the MIB and time index information carried within PBCH. UE obtains the configurations of CORESET (CORESET0) for scheduling SIB1 and the configuration of the search space set (search space set 0) of the CORESET through the information in MIB. Thus, UE can monitor the Type0-PDCCH of PDSCH that schedules and carries SIB1, and decode SIB1. In PBCH, since the bandwidth of CORESET0 is set through a table, the maximum bandwidth of CORESET0 is implicitly defined in a protocol. Furthermore, the protocol specifies that the frequency domain resource of PDSCH carrying SIB1 is within the bandwidth (PRBs) of CORESET0, and thus the maximum bandwidth of PDSCH carrying SIB1 is also implicitly defined in the protocol. In the idle state, UE operates within an initial active DL BWP, the frequency domain position of the initial active DL BWP is the same as that of CORESET0 by default (in non-default cases, the frequency domain position of the initial activated DL BWP may be modified by signaling to cover the frequency domain position of CORESET0). Therefore, the maximum bandwidth of the initial activated DL BWP is implicitly defined in the protocol.

In the related art, UE needs to monitor paging related PDCCH, also known as Type 2-PDCCH, in the idle state or inactive state. The radio network temporary identity (RNTI) of paging related PDCCH is P-RNTI, and the format of the used downlink control information (DCI) is DCI format 1-0. After the user equipment detects paging related PDCCH successfully (successfully descrambling CRC with P-RNTI), the user equipment parses DCI. There may be a short message in DCI to allow the user equipment to obtain alarm information or update system information. There may also be scheduling information in DCI to allow the user equipment to receive paging related PDSCH, obtain a paging message, and further initiate a random access process to enter the connected state. The monitoring occasion of the paging related PDCCH can be configured by SSS, and determined by PO and paging monitoring occasions (PMOs). PO is used to determine a starting point of the monitoring occasion within a paging frame (PF). PMOs are multiple successive monitoring occasions the first one of which is the starting point, and PMOs are associated with the truly transmitted synchronization signal blocks in a one-to-one correspondence. On the other hand, in the idle state or inactive state, the user equipment needs to perform periodic radio resource management (RRM) measurements. The RRM measurements include serving cell measurement and neighboring cell measurement. The neighboring cell measurement generally includes: a frequency point is given by a base station, and the user equipment performs cell search and measurement at the frequency point Or, the frequency point and physical cell ID (PCI) are given by the base station, and the user equipment uses the PCI for cell search and measurement at the frequency point. Or, the base station does not provide frequency point or PCI, and the user equipment independently performs cell search and measurement. The neighboring cell measurement is further divided into intra-frequency measurement and inter-frequency measurement. For example, the measurement is intra-frequency measurement if the center frequency point and subcarrier spacing of the synchronization signal block of the measurement object of neighboring cell are the same as those of the synchronization signal block of serving cell. For example, the measurement is inter-frequency measurement if the center frequency point and subcarrier spacing of the synchronization signal block of the measurement object of neighboring cell are different from those of the synchronization signal block of serving cell. In the idle state or inactive state, the user equipment generally needs to perform the RRM measurements of serving cell within one paging cycle. The paging cycle is also referred to as idle state discontinuous reception (I-DRX) cycle. Therefore, in the idle state or inactive state, the monitoring for paging related PDCCH and the RRM measurements are the main tasks of user equipment.

Regarding the monitoring of paging related PDCCH and the RRM measurements, the user equipment generally wakes up from deep sleep by paging and process three SS/PBCH block bursts (SS bursts), monitors paging related PDCCH in response to the determination that a time-frequency synchronization is reached, and performs the RRM measurements. For this purpose, the network may be configured with PEI, and the user equipment detects a paging early indication before paging related PDCCH. In response to the determination that the PEI indicates that the user equipment needs to monitor paging related PDCCH, the user equipment continues to monitor paging related PDCCH. PEI is generally prior to PO. In response to the determination that the PEI is configured, the user equipment wakes up from deep sleep and process one synchronization signal block burst to achieve a time-frequency synchronization to detect PEI. In response to the determination that the PEI indicates the user equipment needs to monitor paging related PDCCH, the user equipment continues to process two synchronization signal block burst and continues to monitor paging related PDCCH. In response to the determination that the PEI indicates that the user equipment does not need to monitor paging related PDCCH, the user equipment switches back to deep sleep. When a group paging rate is 10%, the probability that the user equipment needs to monitor paging related PDCCH is 10%. Therefore, when the probability is 10%, the user equipment needs to process three synchronization signal block bursts, monitor paging related PDCCH, and perform the RRM measurements. When the probability is 90%, the user equipment only needs to process one synchronous signal block burst and perform the RRM measurements. In this way, with the probability of 90%, the user equipment processes fewer signals or channels, wakes up in a shorter time (if the user equipment wakes up from deep sleep and does not process signals/channels, the user equipment is in light sleep), and has lower power consumption. Therefore, by using the PEI, the user equipment can save power. An integrated receiver is generally used to process synchronization signal block burst and monitor PDCCH (i.e., a receiver shared in the idle state, inactive state, and connected state), such that the conversion power consumption of user equipment waking up from deep sleep is higher, and the power consumption for detecting the PEI is also higher. The integrated receiver, also known as a regular receiver, has a complete radio frequency and baseband processing architecture. The integrated receiver is a receiver shared in the idle state, inactive state, and connected state. The integrated receiver can include a synchronization signal block receiving module, a data receiving module, or a control receiving module in terms of functional modules.

In the related art, in order to reduce the conversion power consumption of user equipment waking up from deep sleep and the power consumption for detection signals, a low-power receiver independent of the integrated receiver may be used to detect a wake-up signal. By using an independent low-power receiver, energy can be saved. There are two receiving methods for this low-power receiver. The first receiving method is to periodically detect the wake-up signal by the low-power receiver. Since there are few devices in the operating state, the conversion power consumption of the low-power receiver waking up from deep sleep is very low. Due to the special design of the corresponding wake-up signal, the low-power receiver consumes less power to detect the wake-up signal. In the second receiving method, the low-power receiver is in a stand-by state capable of detecting the wake-up signal. The low-power receiver does not need to switch between deep sleep and signal detection, so the low-power receiver does not have the conversion power consumption to wake up from deep sleep. However, the low-power receiver actually only has a deep sleep state (also referred to as stand-by state) and can detect the wake-up signal without waking up. The low-power receiver may have three architectures. The first architecture is a more traditional one, including a band-pass filter, a radio frequency amplifier, a local oscillator, a frequency mixer, and a detector, without an analog digital converter (ADC) and digital processing. The second architecture is to use passive circuits as many as possible, including a band-pass filter (passive), an optional radio frequency amplifier (passive), and a detector, without a local oscillator or a frequency mixer. The third architecture uses energy harvesting, which truly achieves zero power consumption. The above three architectures can all implement the two receiving methods mentioned above. Although the low-power receiver can detect the wake-up signal with extremely low power consumption, the wake-up signal carries less information. When the wake-up signal carries a large amount of information, the sequence length of the wake-up signal is longer, and the power consumption for detecting the wake-up signal is higher, which is not conducive to energy conservation.

The PO or the PEI can carry a large amount of information, and needs to be received through the integrated receiver. Therefore, the wake-up signal and the PO or the PEI perform interworking, in other words, the wake-up signal is utilized together with the PO or the PEI to achieve the purposes of significantly saving energy and obtaining more information.

In order to solve the technical problems, embodiments of the present disclosure provide a paging method. The method includes: detecting a wake-up signal successfully, and monitoring a paging occasion (PO) or a paging early indication (PEI).

In some embodiments of the present disclosure, each step is executed by a user equipment. It can be understood that the user equipment monitors the PO or the PEI in response to detecting the wake-up signal successfully.

In some embodiments of the present disclosure, the step of monitoring the PO include receiving a paging related PDCCH. One PO includes one or more paging related PDCCHs.

In some embodiments of the present disclosure, the user equipment can determine whether to directly receive the paging related PDCCH or receive the PEI first according to the situation. In response to a determination that the PEI does not have additional information, the user equipment can directly receive the paging related PDCCH, which can save power consumption for receiving the PEI. In response to a determination that the PEI has additional information, the user equipment can receive the PEI first to determine whether to further receive the paging related PDCCH. In response to a determination that the PEI indicates that there is no need to further receive the paging related PDCCH, the user equipment may not receive the paging related PDCCH.

In an embodiment, the step of detecting a wake-up signal successfully, and monitoring a PO or a PEI includes: monitoring the PO or the PEI according to a higher layer parameter.

In an embodiment, the higher layer parameter is signaling from a base station, the base station can control the user equipment to directly receive the paging related PDCCH, or control the user equipment to receive the PEI first, which is more flexible in control. For example, the PEI can be configured to include a short message, a tracking reference signal (TRS), or a channel state information reference signal (CSI-RS). These information may be specific to all user equipment and is difficult to be carried by the wake-up signal, such that the base station can allow the user equipment to receive the PEI first. It can be understood that the user equipment also detect the wake-up signal according to the higher layer parameter.

In an embodiment, the step of detecting a wake-up signal successfully, and monitoring a PO or a PEI includes: monitoring the PO or the PEI according to a configuration of the PO and/or a configuration of the PEI.

In some embodiments of the present disclosure, the user equipment can receive the paging related PDCCH and/or the PEI according to the configuration of the PO and/or the configuration of the PEI, in such a manner to save signaling cost. The user equipment can receive the paging related PDCCH according to the configuration of the PO. The user equipment can also receive the PEI according to the configuration of the PEI. The user equipment can also receive the PEI or the paging related PDCCH according to the configuration of the PO and the configuration of the PEI.

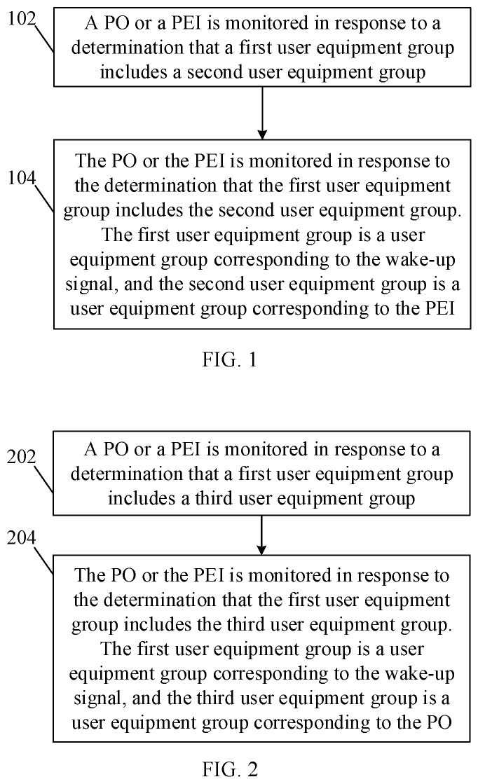

In an embodiment, the step of monitoring the PO or the PEI according to a configuration of the PO and a configuration of the PEI is detailed in the flowcharts shown in FIG. 1 to FIG. 4.

FIG. 1 is a flowchart of a paging method according to an embodiment of the present disclosure. As shown in FIG. 1, the method includes the following steps.

In step 102, a user equipment (UE) monitors the PO or the PEI in response to a determination that a first user equipment group includes a second user equipment group. In an equivalent description of step 102, the UE monitors the PO or the PEI in response to a determination that the second user equipment group is a subset of the first user equipment group or the second user equipment group is the same as the first user equipment group. In an embodiment, the first user equipment group is a user equipment group corresponding to the wake-up signal, and the second user equipment group is a user equipment group corresponding to the PEI. The user equipment group can be considered as a user equipment group number or identity. It can be understood that the user equipment obtains the user equipment group corresponding to the wake-up signal through a configuration of the wake-up signal, and the user equipment obtains the user equipment group corresponding to the PEI through the configuration of the PEI.

In some embodiments of the present disclosure, the second user equipment group has a finer granularity than the first user equipment group.

In some embodiments of the present disclosure, if the first user equipment group includes the second user equipment group, it indicates that the base station wants the user equipment to detect the wake-up signal carrying the first user equipment group number or identity successfully, and then receive the PEI to detect the second user equipment group number or identity carried by the PEI. It can be understood that the user equipment can directly receive the PO according to its own requirements without receiving the PE.

In step 104, the UE monitors the PO or the PEI in response to the determination that the first user equipment group includes the second user equipment group. In an embodiment, the first user equipment group is the user equipment group corresponding to the wake-up signal, and the second user equipment group is the user equipment group corresponding to the PEI.

In some embodiments of the present disclosure, the user equipment group can be considered as the user equipment group number or identity. It can be understood that the user equipment obtains the user equipment group corresponding to the wake-up signal through the configuration of the wake-up signal, and the user equipment obtains the user equipment group corresponding to the PEI through the configuration of the PEI.

In some embodiments of the present disclosure, the first user equipment group includes the second user equipment group. In an embodiment, the first user equipment group is the user equipment group corresponding to the wake-up signal, and the second user equipment group is the user equipment group corresponding to the PEI.

In some embodiments of the present disclosure, the user equipment group can be considered as the user equipment group number or identity. It can be understood that the wake-up signal is associated with the PEI through an inclusion relationship between the first user equipment group and the second user equipment group.

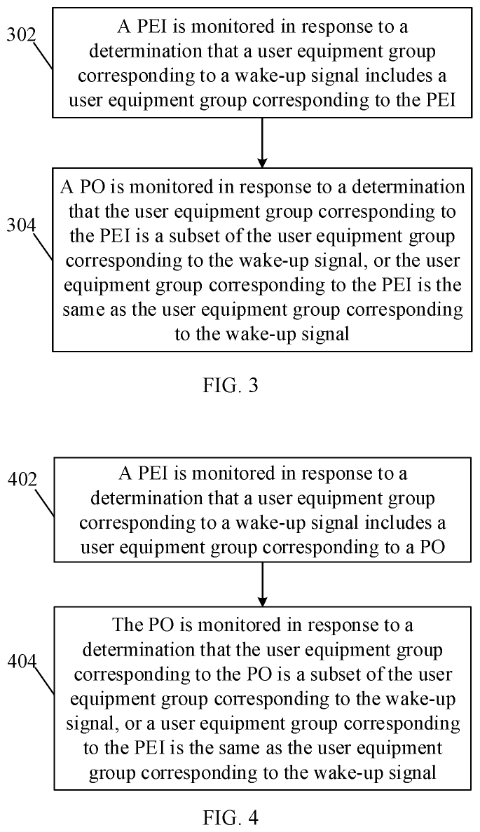

FIG. 2 is a flowchart of another paging method according to an embodiment of the present disclosure. As shown in FIG. 2, the method includes the following steps.

In step 202, the UE monitors the PO or the PEI in response to a determination that the first user equipment group includes a third user equipment group.

In some embodiments of the present disclosure, in an equivalent description of the step 202, the UE monitors the PO or the PEI in response to a determination that the third user equipment group is a subset of the first user equipment group, or the third user equipment group is the same as the first user equipment group. In an embodiment, the first user equipment group is the user equipment group corresponding to the wake-up signal, and the third user equipment group is a user equipment group corresponding to the PO. The user equipment group can be considered as the user equipment group number or identity. It can be understood that the user equipment obtains the user equipment group corresponding to the wake-up signal through the configuration of the wake-up signal, and the user equipment obtains the user equipment group corresponding to the PO through the configuration of the PO.

In some embodiments of the present disclosure, the third user equipment group has a finer granularity than the first user equipment group.

In some embodiments of the present disclosure, if the first user equipment group includes the third user equipment group, it indicates that the base station wants the user equipment to detect the wake-up signal carrying the first user equipment group number or identity successfully, and then receive the PO and detect the third user equipment group number or identity carried by the PO. It can be understood that the user equipment can also receive the PEI according to its own requirements and determine whether to receive the PO according to an instruction of the PEI.

In step 204, the UE monitors the PO or the PEI in response to the determination that the first user equipment group includes the third user equipment group. In an embodiment, the first user equipment group is the user equipment group corresponding to the wake-up signal, and the third user equipment group is the user equipment group corresponding to the PO.

In some embodiments of the present disclosure, the user equipment group can be considered as the user equipment group number or identity. It can be understood that the user equipment obtains the user equipment group corresponding to the wake-up signal through the configuration of the wake-up signal, and the user equipment obtains the user equipment group corresponding to the PO through the configuration of the PO.

In some embodiments of the present disclosure, the first user equipment group includes the third user equipment group. In an embodiment, the first user equipment group is the user equipment group corresponding to the wake-up signal, and the third user equipment group is the user equipment group corresponding to the PO.

In some embodiments of the present disclosure, the user equipment group can be considered as the user equipment group number or identity. It can be understood that the wake-up signal is associated with the PO through an inclusion relationship between the first user equipment group and the third user equipment group.

FIG. 3 is a flowchart of another paging method according to an embodiment of the present disclosure. As shown in FIG. 3, the method includes the following steps.

In step 302, the UE monitors the PEI in response to a determination that the user equipment group corresponding to the wake-up signal includes the user equipment group corresponding to the PEI.

In some embodiments of the present disclosure, the user equipment group corresponding to the PEI has a finer granularity than the user equipment group corresponding to the wake-up signal.

In some embodiments of the present disclosure, if the user equipment group corresponding to the wake-up signal includes the user equipment group corresponding to the PEI, it indicates that the base station wants the user equipment to detect the wake-up signal carrying the user equipment group number or identity successfully, and then receive the PEI and detect the user equipment group number or identity carried by the PEI.

In step 304, the UE monitors the PO in response to a determination that the user equipment group corresponding to the PEI is a subset of the user equipment group corresponding to the wake-up signal, or the user equipment group corresponding to the PEI is the same as the user equipment group corresponding to the wake-up signal.

FIG. 4 is a flowchart of another paging method according to an embodiment of the present disclosure. As shown in FIG. 4, the method includes the following steps.

In step 402, the UE monitors the PEI in response to a determination that the user equipment group corresponding to the wake-up signal includes the user equipment group corresponding to the PO.

In some embodiments of the present disclosure, the user equipment group corresponding to the PO has a finer granularity than the user equipment group corresponding to the wake-up signal.

In some embodiments of the present disclosure, if the user equipment group corresponding to the wake-up signal includes the user equipment group corresponding to the PO, it indicates that the base station wants the user equipment to detect the wake-up signal carrying the user equipment group number or identity successfully, and then receive the PO and detect the user equipment group number or identity carried by the PO.

In step 404, the UE monitors the PO in response to a determination that the user equipment group corresponding to the PO is a subset of the user equipment group corresponding to the wake-up signal, or the user equipment group corresponding to the PEI is the same as the user equipment group corresponding to the wake-up signal.

In some embodiments of the present disclosure, the UE monitors the PEI in response to a determination that the PEI includes a short message, a tracking reference signal (TRS), or a channel state information reference signal (CSI-RS).

For example, the short message, the TRS, or the CSI-RS may be arranged for all user equipment and is difficult to be carried by the wake-up signal. If the information is carried by the PEI, it indicates that the base station wants the user equipment to receive the PEI first.

The paging method according to the embodiment of the present disclosure includes: detecting a wake-up signal successfully, and monitoring a paging occasion (PO) or a paging early indication (PEI). Through the technical solution provided by the embodiment of the present disclosure, the conversion power consumption of user equipment waking up from deep sleep and the power consumption for detecting signals are reduced.

An embodiment of the present disclosure provides another paging method. The method includes: detecting a wake-up signal successfully, and monitoring a PO or a PEI associated with the wake-up signal.

In some embodiments of the present disclosure, the base station knows a time point to send the paging related PDCCH or the PEI to the user equipment, and the user equipment knows a time point to receive the paging related PDCCH or the PEI sent by the base station. The wake-up signal is detected by an independent low-power receiver, while the paging related PDCCH or the PEI is received by an integrated receiver, and the integrated receiver requires a conversion time from off to on. Therefore, the base station and the user equipment need to have a consistent understanding about the sending time point and the receiving time point, in such a manner to achieve correct information transmission.

In some embodiments of the present disclosure, the low-power receiver periodically detects the wake-up signal. Since the low-power receiver periodically detects the wake-up signal, and the integrated receiver also periodically receives the paging related PDCCH or the PEI, the wake-up signal can be associated with the paging related PDCCH or the PEI. In other words, the user equipment periodically detects the wake-up signal, and can receive the paging related PDCCH or the PEI associated to the wake-up signal accordingly in response to the successful detection of the wake-up signal.

In an embodiment, the step of detecting a wake-up signal successfully, and monitoring a PO or a PEI associated with the wake-up signal includes: the wake-up signal is detected before monitoring the PO or the PEI associated with the wake-up signal.

In some embodiments of the present disclosure, after detecting the wake-up signal successfully, the user equipment has enough time to turn on the integrated receiver to receive the paging related PDCCH or the PEI associated to the wake-up signal.

In an embodiment, the step of detecting a wake-up signal successfully, and monitoring a PO or a PEI associated with the wake-up signal includes: the successful detection of the wake-up signal is prior to N synchronization signal block bursts before the PO associated with the wake-up signal. A synchronization signal block burst may be a set of synchronization signal blocks (SS/PBCH blocks) over a period of time. For example, a synchronization signal block burst may be a set of synchronization signal blocks within 5 milliseconds.

In some embodiments of the present disclosure, after detecting the wake-up signal successfully, the user equipment has enough time to turn on the integrated receiver to process N synchronization signal block bursts before the paging related PDCCH associated with the wake-up signal for time-frequency synchronization (tracking) and reception of the paging related PDCCH associated with the wake-up signal. In an embodiment, N can be configured through the higher layer parameter or pre-configured in advance. In an embodiment, N may be a positive integer. The higher layer parameter can improve flexibility. The pre-configuration can save signaling cost. For example, N is configured to be 3 in advance. The user equipment can achieve sufficient time-frequency synchronization accuracy by processing three synchronization signal block bursts, so as to correctly receive the paging related PDCCH associated with the wake-up signal.

In an embodiment, the step of detecting a wake-up signal successfully, and monitoring a PO or a PEI associated with the wake-up signal includes: the successful detection of the wake-up signal is X milliseconds or X time slots prior to the PO associated with the wake-up signal.

In some embodiments of the present disclosure, the X milliseconds include N synchronization signal blocks. The advantages are as follows: the X milliseconds include the conversion time for turning on the integrated receiver and the time of N synchronization signal block bursts before the paging related PDCCH associated with the wake-up signal. N is configured through the higher layer parameter or pre-configured in advance. The higher layer parameter can improve flexibility. The pre-configuration can save signaling cost. For example, N is configured to be 3 in advance. The user equipment can achieve sufficient time-frequency synchronization accuracy by processing three synchronization signal block bursts, so as to correctly receive the paging related PDCCH associated with the wake-up signal.

In an embodiment, the step of detecting a wake-up signal successfully, and monitoring a PO or a PEI associated with the wake-up signal includes: the successful detection of the wake-up signal is prior to M synchronization signal block bursts before the PEI associated with the wake-up signal.

In some embodiments of the present disclosure, after detecting the wake-up signal successfully, the user equipment has enough time to turn on the integrated receiver to process M synchronization signal block bursts before the PEI associated with the wake-up signal for time-frequency synchronization (tracking) and reception of the PEI associated with the wake-up signal. In an embodiment, M can be configured through the higher layer parameter or pre-configured in advance. In an embodiment, M may be a positive integer. The higher layer parameter can improve flexibility. The pre-configuration can save signaling cost. For example, M is configured to be 1 in advance. The user equipment can achieve sufficient time-frequency synchronization accuracy by processing one synchronization signal block burst, so as to correctly receive the PEI associated with the wake-up signal.

In an embodiment, the step of detecting a wake-up signal successfully, and monitoring a PO or a PEI associated with the wake-up signal includes: the successful detection of the wake-up signal is Y milliseconds prior to the PEI associated with the wake-up signal or Y time slots prior to the PEI associated with the wake-up signal.

In some embodiments of the present disclosure, the Y milliseconds include the conversion time for turning on the integrated receiver and the time of M synchronization signal block bursts before the PEI associated with the wake-up signal. In an embodiment, M may be configured through the higher layer parameter or pre-configured in advance. The higher layer parameter can improve flexibility. The pre-configuration can save signaling cost. For example, M is configured to be 1 in advance. The user equipment can achieve sufficient time-frequency synchronization accuracy by processing one synchronization signal block burst, so as to correctly receive the PEI associated with the wake-up signal.

The paging method according to the embodiment of the present disclosure includes: detecting a wake-up signal successfully, and monitoring a PO or a PEI associated with the wake-up signal. Through the method provided by the embodiment of the present disclosure, the conversion power consumption of user equipment waking up from deep sleep and the power consumption for detecting signals are reduced.

An embodiment of the present disclosure provides another paging method. The method includes: detecting the wake-up signal successfully, and monitoring a PO or a PEI after a first time gap.

In some embodiments of the present disclosure, the low-power receiver is always in a stand-by state and detects the wake-up signal. Since the low-power receiver is always in the stand-by state and detects the wake-up signal, the wake-up signal does not need to be associated with the paging related PDCCH or the PEI. In other words, the user equipment detects the wake-up signal and determines a reference time point, such as an end time point of the wake-up signal, and the base station can use the reference time point as a reference to determine the time point for the user equipment to receive the paging related PDCCH or the PEI.

In an embodiment, the step of detecting the wake-up signal successfully, and monitoring a PO or a PEI after a first time gap includes: detecting the wake-up signal successfully, and monitoring the PO or the PEI after a first time point.

In some embodiments of the present disclosure, the first time point includes the time point agreed upon by both the base station and the user equipment. For example, the first time point is the end time point of the wake-up signal.

In some embodiments of the present disclosure, after detecting the wake-up signal, the user equipment determines the first time point and turns on the integrated receiver after the first time point. Therefore, the user equipment has enough time to turn on the integrated receiver to receive the paging related PDCCH or the PEI. In an embodiment, the first time point is a time point after the end time point of the wake-up signal. The first time point can depend on how long it takes for the user equipment to turn on the integrated receiver after the end time point of the wake-up signal. The first time point can depend on a capability of the user equipment.

In an embodiment, the step of detecting the wake-up signal successfully, and monitoring a PO or a PEI after a first time gap includes: detecting the wake-up signal successfully, and monitoring the PO after N synchronization signal block bursts subsequent to a first time point.

In some embodiments of the present disclosure, after detecting the wake-up signal successfully, the user equipment has enough time to turn on the integrated receiver and process N synchronization signal block bursts before the paging related PDCCH for time-frequency synchronization (tracking) and reception of the paging related PDCCH. In an embodiment, N may be configured through the higher layer parameter or pre-configured in advance, and N may be a positive integer. The higher layer parameter can improve flexibility. The pre-configuration can save signaling cost. For example, N is configured to 3 in advance. The user equipment can achieve sufficient time-frequency synchronization accuracy by processing three synchronization signal block bursts, so as to correctly receive the paging related PDCCH.

In an embodiment, the step of detecting the wake-up signal successfully, and monitoring a PO or a PEI after a first time gap includes: detecting the wake-up signal successfully, and monitoring the PO X milliseconds after a first time point or X time slots after the first time point.

In some embodiments of the present disclosure, the X milliseconds or X time slots include N synchronization signal block bursts.

In some embodiments of the present disclosure, the X milliseconds include the conversion time for turning on the integrated receiver and the time of N synchronization signal block bursts before the paging related PDCCH. In an embodiment, N is configured or pre-configured through the higher layer parameter. The higher layer parameter can improve flexibility. The pre-configuration can save signaling cost. For example, N can be equal to 3 in response to the determination that N is pre-configured. The user equipment can achieve sufficient time-frequency synchronization accuracy by processing three synchronization signal block bursts, so as to correctly receive the paging related PDCCH.

In an embodiment, the step of detecting the wake-up signal successfully, and monitoring a PO or a PEI after a first time gap includes: detecting the wake-up signal successfully, and monitoring the PEI after M synchronization signal block bursts subsequent to a first time point.

In some embodiments of the present disclosure, after detecting the wake-up signal successfully, the user equipment has enough time to turn on the integrated receiver and process M synchronization signal block bursts before the PEI for time-frequency synchronization (tracking) and reception of the PEI. In an embodiment, M is configured through the higher layer parameter or pre-configured. The higher layer parameter can improve flexibility. The pre-configuration can save signaling cost. For example, M is configured to be 1 in advance. The user equipment can achieve sufficient time-frequency synchronization accuracy by processing one synchronization signal block burst, so as to correctly receive the PEI.

In an embodiment, the step of detecting the wake-up signal successfully, and monitoring a PO or a PEI after a first time gap includes: detecting the wake-up signal successfully, and monitoring the PEI Y milliseconds after a first time point or Y time slots after the first time point.

In some embodiments of the present disclosure, the Y milliseconds or Y time slots include M synchronization signal block bursts.

In some embodiments of the present disclosure, the Y milliseconds include the conversion time for turning on the integrated receiver and the time of M synchronization signal block bursts before the PEI. In an embodiment, M can be configured through the higher layer parameter or pre-configured, and M may be a positive integer. The higher layer parameter can improve flexibility. The pre-configuration can save signaling cost. For example, M may be configured to be 1 in advance. The user equipment can achieve sufficient time-frequency synchronization accuracy by processing one synchronization signal block burst, so as to correctly receive the PEI.

The technical solution of the paging method according to the embodiment of the present disclosure includes: detecting the wake-up signal successfully, and monitoring a PO or a PEI after a first time gap. Through the technical solution provided by the embodiment of the present disclosure, the conversion power consumption of user equipment waking up from deep sleep and the power consumption for detecting signals are reduced.

An embodiment of the present disclosure provides a paging method. The method includes: stopping detecting a wake-up signal within a second time gap.

In some embodiments of the present disclosure, in order to ensure a reliability of the wake-up signal detection, the wake-up signal requires a longer sequence length, thus the corresponding cost is relatively high. In order to ensure mobility management, the user equipment needs to periodically perform the RRM measurements to select/reselect the cell in a timely manner and maintain a good coverage in the cellular network. Due to the need for periodic RRM measurements, at some moments, the integrated receiver needs to be turned on to process the synchronization signal block burst. For the RRM measurements of serving cell, the user equipment generally performs one RRM measurement within one paging cycle and obtains a measurement sample. For the user equipment that moves at a low speed or is in a stationary state, the base station can configure a measurement relaxation (including RRM measurement relaxation of serving cell) for the purpose of saving power, that is, the user equipment is configured to perform one RRM measurement within multiple paging cycles and obtain one measurement sample. Therefore, the user equipment still needs to turn on the integrated receiver once within multiple paging cycles to process the synchronization signal burst and perform the RRM measurements. In order to save the cost of the wake-up signal, the base station can directly send paging related PDCCH and/or the PEI without sending the wake-up signal in response to a determination that the user equipment turns on the integrated receiver. This is because the user equipment has already turned on the integrated receiver and can incidentally receive the paging related PDCCH and/or the PEI. It should be noted that both the base station and the user equipment need to agree on a period of time during which the base station does not send the wake-up signal, and the user equipment stops detecting (does not detect) the wake-up signal, but instead receives the paging related PDCCH and/or the PEI. Both the base station and the user equipment can generally agree to stop detecting (does not detect) the wake-up signal within a time window. In other word, the user equipment stops detecting (does not detect) the wake-up signal within the second time gap. The expression “the user equipment stops detecting the wake-up signal” herein indicates that “the user equipment does not detect the wake-up signal”.

In an embodiment, the step of stopping detecting a wake-up signal within a second time gap includes: stopping detecting all wake-up signals, in one paging cycle of P paging cycles, associated with a PO.

In some embodiments of the present disclosure, since the low-power receiver periodically detects the wake-up signal, the detection occasion of the wake-up signal can be associated with the PO. Therefore, the base station and the user equipment can agree that the user equipment perform the RRM measurements within one paging cycle of P paging cycles, and the base station does not send the wake-up signal during the paging cycle (during which the user equipment has already turned on the integrated receiver for the RRM measurements), so as to save the cost of the wake-up signal.

In an embodiment, the step of stopping detecting all wake-up signals, in one paging cycle of P paging cycles, associated with a PO includes: stopping detecting all wake-up signals, in a first paging cycle or a last paging cycle of the P paging cycles, associated with the PO.

In some embodiments of the present disclosure, the base station and the user equipment make an agreement that the user equipment performs the RRM measurement in the first paging cycle or the last paging cycle of the P paging cycles, which is relatively easy to implement.

In an embodiment, the step of stopping detecting a wake-up signal within a second time gap includes: stopping detecting the wake-up signal within a time window.

In some embodiments of the present disclosure, since the low-power receiver is always in the stand-by state and detects the wake-up signal, a time window may be arranged, and the base station and the user equipment make an agreement that the wake-up signal is not sent/detected within the time window.

In some embodiments of the present disclosure, a duration of the time window includes: a duration of a synchronization signal block burst, or a duration of a SS/PBCH block measurement timing configuration (SMTC).

In some embodiments of the present disclosure, the SMTC is the measurement window configured by a higher layer. Within the time window containing the synchronization signal block burst, the user equipment can perform the RRM measurement on the synchronization signal block burst. Within the time window containing the SMTC, the user equipment can perform the RRM measurement on the synchronization signal block within the SMTC.

In some embodiments of the present disclosure, a duration of the time window includes: a duration of N synchronization signal block bursts and a duration of the PO, or the duration of N synchronization signal bursts, the duration of the PO and a duration of the SMTC.

In some embodiments of the present disclosure, since the user equipment needs to perform the RRM measurements within the time window, the user equipment may also receive the paging related PDCCH. In order to correctly receive the paging related PDCCH, N synchronization signal bursts need to be processed, thus the time window needs to include N synchronization signal bursts. The transmission time of N synchronization signal bursts can also include the SMTC. In an embodiment, N can be configured through the higher layer parameter or pre-configured, and N may be a positive integer. The higher layer parameter can improve flexibility. The pre-configuration can save signaling cost. For example, N is configured to be 3 in advance. The user equipment can achieve sufficient time-frequency synchronization accuracy by processing three synchronization signal block bursts, so as to correctly receive the paging related PDCCH.

In some embodiments of the present disclosure, a duration of the time window is X milliseconds or X time slots. In an embodiment, the X milliseconds or X time slots include: the duration of N synchronization signal block bursts and the duration of the PO; or the duration of N synchronization signal bursts, the duration of the PO and the duration of the SMTC.

In some embodiments of the present disclosure, the X milliseconds or X time slots include the conversion time for turning on or off the integrated receiver, the time required for the RRM measurement, and the time required to receive the paging related PDCCH.

In some embodiments of the present disclosure, a duration of the time window includes: the duration of N synchronization signal bursts, a duration of the PEI and the duration of the PO; or the duration of N synchronization signal bursts, the duration of the PEI, the duration of the PO and the duration of the SMTC.

In some embodiments of the present disclosure, since the user equipment needs to perform the RRM measurements within the time window, the user equipment may receive the PEI and the paging related PDCCH which may be indicated by the PEI. In order to correctly receive the PEI and the paging related PDCCH which may be indicated by the PEI, N synchronization signal bursts may need to be processed (only the first M ones of N synchronization signal blocks need to be processed if the PEI indicates not receiving the paging related PDCCH), thus the time window may need to include N synchronization signal bursts. The transmission time of N synchronization signal bursts can also include the SMTC.

In some embodiments of the present disclosure, a duration of the time window is X milliseconds or X time slots. In an embodiment, the X milliseconds or X time slots include: the duration of N synchronization signal bursts, the duration of the PEI and the duration of the PO; or the duration of N synchronization signal bursts, the duration of the PEI, the duration of the PO, and the duration of the SMTC.

In some embodiments of the present disclosure, the X milliseconds or X time slots include the conversion time for turning on or off the integrated receiver, the time required for the RRM measurement, and the time required to receive the PEI and the paging related PDCCH which may be indicated by the PEI.

The technical solution of the paging method according to the embodiment of the present disclosure includes: stopping detecting a wake-up signal within a second time gap. Through the technical solution provided by the embodiment of the present disclosure, the conversion power consumption of user equipment waking up from deep sleep and the power consumption for detecting signals are reduced.

An embodiment of the present disclosure provides a computer-readable storage medium, and the computer-readable storage medium includes a program stored therein. In an embodiment, the program, when being executed, causes an equipment equipped with the computer-readable storage medium to implement the steps of the paging methods according to the above embodiments. The specific description can be found in the above embodiments about the paging methods.

An embodiment of the present disclosure provides a user equipment, and the user equipment includes one or more processors, a memory, and one or more computer programs. In an embodiment, the one or more computer programs are stored in the memory, the one or more computer programs include instructions, and the instructions, when being executed by the user equipment, cause the user equipment to implement the steps of the paging methods according to the above embodiments. The specific description can be found in the above embodiments about the paging methods.

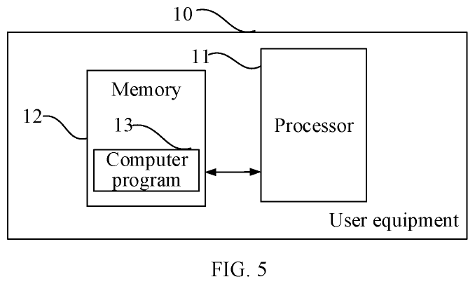

FIG. 5 is a schematic diagram of a user equipment according to an embodiment of the present disclosure. As shown in FIG. 5, the user equipment 10 includes a processor 11, a memory 12, and a computer program 13 stored in the memory 12 and executable by the processor 11. The computer program 13, when being executed by the processor 11, can achieve the paging methods according to the embodiments. In order to avoid repetition, here no longer gives unnecessary detail.

The user equipment 10 includes, but is not limited to, the processor 11 and the memory 12. Those skilled in the art can understand that FIG. 5 is only an example of the user equipment 10 and does not constitute a limitation on the user equipment 10. The user equipment 10 may include more or fewer components than illustrated, or a combination of some components, or the components different from illustrated. For example, the user equipment may also include an input/output device, a network access device, a bus, etc.

The processor 11 may be a central processing unit (CPU), or other general-purpose processor, digital signal processor (DSP), application specific integrated circuit (ASIC), field-programmable gate array (FPGA), or other programmable logic device, discrete gate or transistor logic device, discrete hardware assembly, etc. The general-purpose processor may be a microprocessor or any conventional processor.

The memory 12 may be an internal storage unit of the user equipment 10, such as a hard disk or internal memory of the user equipment 10. The memory 12 may also be an external storage device of the user equipment 10, such as a plug-in hard disk, smart media card (SMC), secure digital (SD) card, flash card, etc. equipped on the user equipment 10. Furthermore, the memory 12 may also include both the internal storage unit of the user equipment 10 and the external storage device. The memory 12 is used to store the computer program and other programs and data required by the user equipment. The memory 12 can also be used to temporarily store data that has been or will be output.

Those skilled in the art can clearly understand that for the convenience and conciseness of the description, the specific working processes of the system, device, and unit described above can refer to the corresponding processes in the above-mentioned method embodiments, and here no longer gives unnecessary detail.

In the several embodiments provided by the present disclosure, it should be understood that the disclosed system, device, and method can be implemented in other ways. For example, the device embodiments described above are only illustrative. For example, the division of units is only a logical function division, and there may be other division methods in actual implementation. For example, multiple units or assemblies may be combined or integrated into another system, alternatively, some features may be ignored or not executed. On the other hand, the mutual coupling or direct coupling or communication connection displayed or discussed may be indirect coupling or communication connection through some interfaces, devices or units, and may be in the form of electrical, mechanical or other forms.

The units described as separate components may be or may not be physically separated, and the components displayed as units may be or may not be physical units, that is, they may be located in one position or distributed across multiple network units. Some or all units can be selected according to actual needs to achieve the purpose of the embodiment.

In addition, each functional unit in each embodiment of the present disclosure can be integrated into one processing unit. Alternatively, each unit exists physically separately. Alternatively, two or more units are integrated into one unit. The integrated units mentioned above can be implemented separately in the form of hardware, as well as in the form of hardware and software functional unit.

The integrated unit implemented in the form of software functional unit mentioned above can be stored in a computer-readable storage medium. The software functional unit mentioned above is stored in the storage medium, including several instructions to enable a computer device (which may be a personal computer, server, or network device, etc.) or processor to execute some steps of the methods described in the various embodiments of the present disclosure. The aforementioned storage medium includes: USB flash disk, portable hard disk, read-only memory (ROM), random access memory (RAM), magnetic disk or CD, and other medium that can store program codes.

The above are only some preferred embodiments of the present disclosure and are not intended to limit the present disclosure. Any modifications, equivalent substitutions, improvements, etc. made within the spirit and principle of the present disclosure shall be fall within the protection scope of the present disclosure.

1. A paging method, comprising:
detecting a wake-up signal successfully; and
monitoring a paging occasion (PO) or a paging early indication (PEI).

2. The method according to claim 1, wherein said detecting a wake-up signal successfully, and monitoring a PO or a PEI comprises: monitoring the PO or the PEI according to a higher layer parameter.

3. The method according to claim 1, wherein said monitoring a PO or a PEI comprises:
monitoring the PO or the PEI according to a configuration of the PO and/or a configuration of the PEI.

4. The method according to claim 1, wherein
monitoring the PO or the PEI in response to a determination that a first user equipment group comprises a second user equipment group, and wherein the first user equipment group is a user equipment group corresponding to the wake-up signal, and the second user equipment group is a user equipment group corresponding to the PEI.

5. The method according to claim 1, wherein
a first user equipment group comprises a second user equipment group, and wherein the first user equipment group is a user equipment group corresponding to the wake-up signal, and the second user equipment group is a user equipment group corresponding to the PEI.

6. The method according to claim 1, wherein
monitoring the PO or the PEI in response to a determination that a first user equipment group comprises a third user equipment group, and wherein the first user equipment group is a user equipment group corresponding to the wake-up signal, and the third user equipment group is a user equipment group corresponding to the PO.

7. The method according to claim 1, wherein
a first user equipment group comprises a third user equipment group, and wherein the first user equipment group is a user equipment group corresponding to the wake-up signal, and the third user equipment group is a user equipment group corresponding to the PO.

8. The method according to claim 3, wherein
monitoring the PEI in response to a determination that the configuration of the PEI comprises information on a short message, a tracking reference signal (TRS), or a channel state information reference signal (CSI-RS).

9. A paging method, comprising:
detecting a wake-up signal successfully; and
monitoring a paging occasion (PO) or a paging early indication (PEI) associated with the wake-up signal.

10-14. (canceled)

15. The method according to claim 9, further comprising:
detecting the wake-up signal successfully; and
monitoring a PO or a PEI after a first time gap.

16. The method according to claim 15, wherein said detecting the wake-up signal successfully; and monitoring a PO or a PEI after a first time gap comprises:
detecting the wake-up signal successfully, and monitoring the PO or the PEI after a first time point.

17. The method according to claim 15, wherein said detecting the wake-up signal successfully; and monitoring a PO or a PEI after a first time gap comprises:
detecting the wake-up signal successfully, and monitoring the PO after N synchronization signal block bursts subsequent to a first time point.

18. The method according to claim 15, wherein said detecting the wake-up signal successfully; and monitoring a PO or a PEI after a first time gap comprises:
detecting the wake-up signal successfully, and monitoring the PO X milliseconds after a first time point or X time slots after the first time point.

19. The method according to claim 18, wherein the X milliseconds or the X time slots comprise N synchronization signal block bursts.

20. The method according to claim 15, wherein said detecting the wake-up signal successfully; and monitoring a PO or a PEI after a first time gap comprises:
detecting the wake-up signal successfully, and monitoring the PEI after M synchronization signal block bursts subsequent to a first time point.

21. The method according to claim 15, wherein said detecting the wake-up signal successfully; and monitoring a PO or a PEI after a first time gap comprises:
detecting the wake-up signal successfully, and monitoring the PEI Y milliseconds after a first time point or Y time slots after the first time point.

22. The method according to claim 21, wherein the Y milliseconds or the Y time slots comprise M synchronization signal block bursts.

23. The method according to claim 16, wherein the first time point is an end time point of the wake-up signal.

24-32. (canceled)

33. A non-transitory computer-readable storage medium, comprising a program stored therein, wherein the program, when being executed, causes an equipment equipped with the computer-readable storage medium to implement the paging method according to claim 1.

34. A user equipment, comprising:
one or more processors; a memory; and one or more computer programs, wherein the one or more computer programs are stored in the memory, the one or more computer programs comprise instructions, and the instructions, when being executed by the user equipment, cause the user equipment to: detect a wake-up signal successfully; and monitor a paging occasion (PO) or a paging early indication (PEI).
